(19) United States
(12) Patent Application Publication
(10) Pub. No.: US 2007/0276709 A1
(43) Pub. Date: Nov. 29, 2007

(54) Pathfinding System

(76) Inventors: Martin W. Trimby, Suffolk (GB); Marco FP. Gillies, Greater London (GB); Daniel Ballin, Suffolk (GB)

Correspondence Address: NIXON & VANDERHYE, PC, 901 NORTH GLEBE ROAD, 11TH FLOOR, ARLINGTON, VA, 22203, US

(21) Appl. No.: 10/594,123

(22) PCT Filed: Mar. 14, 2005
(86) PCT No.: PCT/GB05/00969

§ 371 Date: Sep. 25, 2006

(30) Foreign Application Priority Data
Mar. 31, 2004 (GB) 0407336.7

(51) Int. Cl. G01C 21/34

(52) U.S. Cl. 705/6

(57) ABSTRACT

A method of generating a new path to a destination node (29G) in a virtual environment comprising a plurality of nodes (29A-G). The method comprises nodal information identifying one or more nodes associated with a previously created path to said destination node, dynamically reconfiguring the topology of the virtual environment to define a start node (29A) for said new path, and processing said stored nodal information to determine the new path to said destination (29G) by including at least one node of said previously created path.

This invention relates to a method and system for determining a path along a plurality of points in a representation of a virtual world. In particular, but not exclusively the invention relates to a method and system for generating a new path to a destination node in a virtual environment which uses stored information associated with a previous path to the destination.

The new path may be generated to enable a participant in the virtual environment to toggle from a manual navigation mode to an automatic navigational mode. The ability for a participant in a virtual world to switch, or toggle, between automated navigational modes of a navigation system and semi-autonomous or directly controlled modes of the navigational system is very desirable. However, it is also desirable for a user to be able to toggle between navigational modes of navigation systems arranged to enable a user to navigate along a path in the real world, as well as systems which enable a user to navigate along a path in a virtual environment.

It is known in many prior art real world system, such as, for example, car navigation systems, for a route to be determined by a user entering a start point and a destination point, and for the navigation system to dictate directions for the user to follow which constrain the user to following a predetermined path from the start to the destination. If, however, the user wishes to leave the predetermined path, for example, to perform a detour, the navigational system will attempt to redirect the user back towards the destination. Usually, the navigational system will seek out the closest point along the original route for the user to return to, and the user will then resume their original path.

Systems in which 3-dimensional virtual reality environments (virtual worlds) are defined and created are becoming increasingly prevalent in the current technological age. Such computer systems are applicable in numerous commercial applications, such as for online tourist sites, fantasy worlds, gaming, architectural walk-throughs, estate agency (virtual tours of houses for sale), and many others. Typically, a virtual world might be defined by multiple x,y,z, co-ordinate sets which together map out an environment in three dimensions (x, y, and z axes). The topology of the virtual world can be defined by way in which the objects within the virtual world are organized within the three dimensions, i.e., by the spatial location of a number of nodal points (also referred to herein as “nodes”). In this case, the topology is determined by the logical mesh which can be formed from nodes at specific co-ordinates in the world. The mesh may or may not be regularly spaced.

Objects and walls (or other items which exist within the virtual world), which a user navigating through the virtual world is not allowed to walk through, can be implemented by what is termed a collisionable mesh. The collisionable mesh may therefore comprise a further set of three dimensional co-ordinates defining shapes within the virtual world which the user must navigate around.

Navigation is required within virtual worlds for any entity passing through that world, such as a computer generated person, vehicle or gaming character. This is typically under the control of an external human user. Traditionally, many commercial implementations of virtual environments have been built on the basis of the self-navigation techniques inherited from games engines, where exploration of all areas of an unknown virtual world is expected, and also a high degree of user competency is assumed. However, as the application of virtual worlds spreads into other commercial areas, it is important that the functionality of navigation evolves to suit the competency and requirements of a whole new wider group of users. Such users may not be as proficient in the navigation around virtual worlds, and furthermore may be disinclined to spend large amounts of time familiarizing themselves with the environment. They are likely to become disorientated or bored much more quickly, or even miss important content entirely, unless the user experience is significantly improved.

In our day-to-day lives, humans typically employ various techniques to help us with our navigation when moving from place to place. We retain an idea of our location and orientation using fixed points of reference (landmarks), measures of distance travelled and changes in direction so as to prevent ourselves becoming disorientated. Such techniques may not be available to the novice user in a virtual world which they are unfamiliar, particularly if teleporting (e.g. instantaneously transferring between two different points in the world) is applied, as is the case in many gaming environments. Consequently, it is advantageous to provide an automated pathfinding system for the inexperienced user to help them navigate them through the virtual world, allowing them to overcome the problems of lack of familiarity and any frustrations with the traditional interface of self-navigation. Consequently, many systems have been developed which automatically calculate the best path through a virtual world, for example to find the shortest path to view a particular object or to pass through a room.

### PRIOR ART

Barber describes a navigational system in United States Patent Application No. Us 2002/0175918A1, entitled “Method as System for implementing a path network in a computer graphics scene”. Barber et al describe a method for implementing a path network for controlling motion behaviors of at least one object in a computer graphics scene. The path network is formed by a plurality of nodes and segments. Various parameters affiliated with the nodes or the segments are defined for establishing motion conditions for the object to travel along the path network. Common to all modes of the path network that Barber et al describe are the parameters EntryPoint and ExitPoint. An Entry Point is a specified path network node or other predefined position on the path network. However, Barber et al do not disclose any specific algorithms to direct an object to get on or off the path network, and the entry and exit points that Barber et al describes are predetermined by the designer of the system. Thus it is not possible in a world such as Barber describes for a user to follow a guided path along which they are automatically navigated, and then to toggle into manual mode and stray from the path, and then toggle back to automatic mode and resume their original path.

Poppen et al describe in U.S. Pat. No. 6,038,509 a pathfinding system which provides a user with a set of directions for following a path from an origin to a destination in a network. If the user deviates from the path, the system recalculates a new path which directs the user from the user's new location, which is off the original path, to the destination. The system adds links to the network to decrease the amount of time needed to determine the new path to the destination. A new path is determined from the new location of the user to the destination using the augmented network. In order for the system to calculate a new path, a new origin is determined either at a pre-existing node where the user is located, or at a pre-existing node of the network which the user specifies as the new origin, or the system can determine the new origin to be some distance away from the user's current position so that the user is able to be at the estimated new origin at when the method for recalculating the path is completed. However, the network which Poppen et al describe comprises a nodal system in which the nodes are fixed and predetermined. The pathfinding system is constrained by the fixed topology of the network which constrains the path to specific nodes of the network.

Known pathfinding algorithms work by expanding possible paths, one node at a time until a path from the start node to the destination node is found. The order in which the nodes are attempted is critical to the speed and quality (e.g. length) of the final path that is found. In a breadth-first techniques, the algorithm searches firstly through all a nodes' immediate neighbors, and then moving onto the neighbors of those neighboring nodes. In contrast, in depth-first techniques, the algorithm searches for a path recursively using a child node each time until reaching a predetermined depth, at which point it retraces its steps and tries other child nodes. A best-first search chooses paths preferentially on the basis of an estimate of the shortest remaining distance to the goal.

The article entitled “Middleware Solutions for Artificial Intelligence in Computer Games” (Chapter 3—AI Techniques) by Jan-Harald Fredriksen of the Norwegian University of Science and Technology, located at http://www.idi.ntnu.no/grupper/su/fordypningsprosjekt-2003/fordypning2003-Jan-Harald-Fredriksen.pdf is concerned with pathfinding techniques in virtual worlds, and the use of the A* algorithm. This document considers the use of cost constraints for different terrains to be taken into account when calculating a path through the virtual world, and the use of hierarchical pathfinding (finding a broad overall route before computing the detailed portions) and portals (which split regions of the virtual world into smaller parts) for improved computation performance. The underlying structure of the virtual world on which the pathfinding in this document is based has two alternative versions. The first is referred to as the POV (points of visibility) approach, in which a plurality of nodes (called waypoints) are introduced into the virtual world, and which the path is found on the basis of line-of-sight links between the nodes. The second approach is the use of a navigation mesh in which a plurality of convex polygons cover the surface of the world, and in this case the pathfinding algorithm considers each polygon to be a node and calculates a path through the virtual world accordingly.

In addition, there currently exist systems for automating the plotting of travel routes through parts of the real world. A good example of such a system is the “Route Planner” tool provided on the web-site of The AA organization (see http://www.theAA.com). Such systems take into account certain preferences of the user (e.g. to avoid motorways, shortest distance, shortest time, etc). However the present inventors are not aware of any systems which enable routes to take account of less utilitarian preferences of users in anything less than a very rudimentary manner. Also, such systems are necessarily restricted to calculating a route along predefined paths (i.e. where roads exist), and are therefore restricted in the flexibility of the final route that is generated.

The invention seeks to obviate and/or mitigate the limitations of known navigational systems which provide means to toggle between automated and manual navigation modes. The navigational toggle system according to the invention is implemented in a system comprising a dynamically varying topology of nodal points, where a guided path may be generated dynamically. As the position of the nodes in the environment and the network of potential links between nodes of the environment is not predetermined, the user is provided with more freedom to toggle between automated and manual navigation modes.

### SUMMARY OF THE INVENTION

The aspects of the invention are as described by the accompanying independent claims whose dependent claims represent preferred features of the invention.

Nonetheless those skilled in the art will appreciate that the preferred features may be suitably combined with any of the aspects of the invention in any appropriate manner apparent to those skilled in the art.

In the navigation system according to the invention, the position of navigational points of the network is not predetermined. Moreover, the navigational paths are which are generated within the topology are not confined to a predetermined configuration. Thus when a user toggles from an automated navigational mode to move away from a predetermined guided path the topology, the nodal points of the topology may be redefined according to the user's change of position. Moreover, when the user wishes to resume an automated path and toggles back from a manual navigation mode to a navigational mode in which the user is automatically navigated along a guided path, the navigational nodes which exists within the network at the point when they left the first guided path may have been redefined.

In addition, the user is not constrained to exit the guided path at one of the navigational nodes of the network. Instead, the user is able to switch freely at any point to a manual navigation node. An exit node may be created at the point where a user leaves the original guided path. The exit node may be a navigational type of node augmented with one or more specific features, such as for example, a specific type of sphere of influence.

For example, in one embodiment of the invention, a sphere of influence node is dynamically generated around an exit node created when the user toggles to a manual navigation mode. If the user navigates themselves beyond this sphere, the option for the user to rejoin the original path generated from the start to the destination may expire. Alternatively, a time-limit on the time the user spends away from the original path may also cause this option to expire. In either case, the option to rejoin is automatically disabled as the user will have wandered too far away (or has spent so long away), that the original path is now obsolete. For example, if a user has wandered to the other side of the original destination, so that the user would want to approach the destination from a completely different angle, it would not be an efficient use of computational time/performance for a search to be performed to determine an optimal path rejoining the original path.

The navigation system is provided within a virtual environment within which the density of points within the virtual environment which define a path between an initial starting point and an initial destination are not fixed and which can vary according to a number of conditions, such that the topology of points determining a path between two points can be dynamically changed as the path itself is plotted. This enables a path to be provided within a virtual world environment along which a user can be automatically navigated. The topology of the path and/or the speed at which the user is automatically navigated along the path enables the user to encounter one or more objects of interest.

One or more objects which the guided path seeks to guide the user towards may be dynamically varying (for example, in terms of their position within the virtual world). This is particularly so in virtual environments where a user may be able to interact via characters within the virtual world with each other. For example, if one of the characters is controlled by another user participating within the same virtual environment, the dynamic path may change if that character is retired from the virtual world by the user controlling it.

This invention is applicable to any type of virtual world, which might include for example fantasy worlds or worlds based upon a real environment such as a historic building or design for a future building, or a house that is for sale, and in which the obstructions might comprise walls or other obstacles. The representation in the sense used above is likely to refer to stored digital data that represents such a world.

Advantageously, the arrangements of the invention employ a technique which allows a content provider to define some initial points for navigation in a virtual world, allowing the content provider to influence the routes taken and the items of interest that can be visited by a user. The system then automatically multiplies the number of points in a manner which will improve the user's experience along the subsequently generated path through the environment compared with only a limited set of originally defined navigation points.

In comparison with previously known systems in which a path through a virtual world is not constrained to specific navigation points, the embodiments of the invention provide improved processing during the actual pathfinding procedure. This is because no collision detection (ensuring the path avoids obstacles, etc) is required during pathfinding in the embodiments since all the new navigable nodes and links have been added on line of sight principles, and therefore by definition already avoid all the potential obstacles.

Additionally, these embodiments provide advantages over previous known systems such as the AA Routefinder which are necessarily limited to finding routes along specified predefined roads, etc. In contrast, in the embodiments, the user is able to navigate within all areas of the virtual world.

### BRIEF DESCRIPTION OF THE DRAWINGS

For a better understanding of the present invention, specific embodiments will now be described, by way of example, with reference to the accompanying drawings, in which:

FIG. 1 shows a schematic of a system for pathfinding in a virtual world environment;

FIG. 2 shows a diagrammatic representation of a virtual world environment;

FIGS. 3 to 12 show further diagrammatic representations of the virtual world environment of FIG. 2; and

FIG. 13 shows a flow chart of the method for processing points within a virtual world;

FIG. 14 shows a flow chart describing a method of toggling between navigational modes within a virtual environment according to a first embodiment of the invention;

FIG. 15 shows a flow chart describing a method of toggling between navigational modes within a virtual environment according to a second embodiment of the invention;

FIG. 16 shows a flow chart describing a method of toggling between navigational modes within a virtual environment according to a third embodiment of the invention; and

FIG. 17 shows a flow chart describing a method of toggling between navigational modes within a virtual environment according to a fourth embodiment of the invention.

FIG. 18 shows schematically a virtual environment in which a user has left an automated path according to one embodiment of the invention;

FIGS. 19A, 19B and 19C show schematically how a return path to an automated path may be determined according to the embodiment of the invention shown in FIG. 14;

FIGS. 20A and 20B show schematically how a return path to an automated path may be determined according to the embodiment of the invention shown in FIG. 15;

FIG. 21 shows schematically how a return path to an automated path may be determined according to the embodiment of the invention shown in FIG. 16; and

FIG. 22 shows schematically how a return path to an automated path may be determined according to the embodiment of the invention shown in FIG. 17.

### DETAILED DESCRIPTION OF EMBODIMENTS OF THE INVENTION

The best mode of the invention currently contemplated by the inventors will now be described with reference to the accompanying drawings.

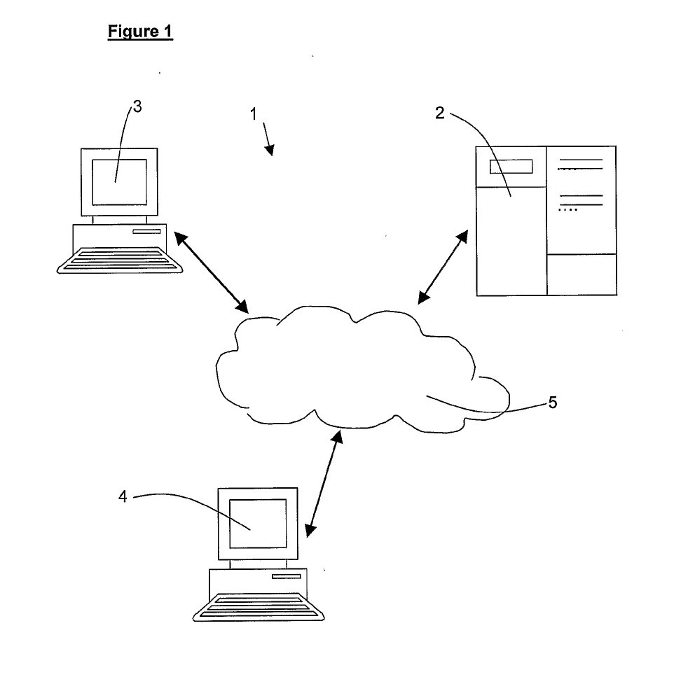

The invention enables a path to be generated which includes nodal information derived from a first, previous path. One navigational system which enables the first path to be generated will now be described with reference to FIGS. 1 to 13 of the accompanying drawings.

FIG. 1 illustrates a system 1 for creating, and allowing a user to navigate within, a virtual world. The system comprises a server computer 2, accessible to a content provider (a human user who will input the specification for the virtual world) via terminal 3, and accessible to a user (desiring to view and navigate through the virtual world) via another terminal 4. In this particular embodiment, access from both terminals to the server 2 is through a general network 5, such as for example the internet, although it is understood that the illustrated computer arrangement may be replaced by any suitable alternative which allows a content provider to design and implement a virtual world, which a user can subsequently access and interact with.

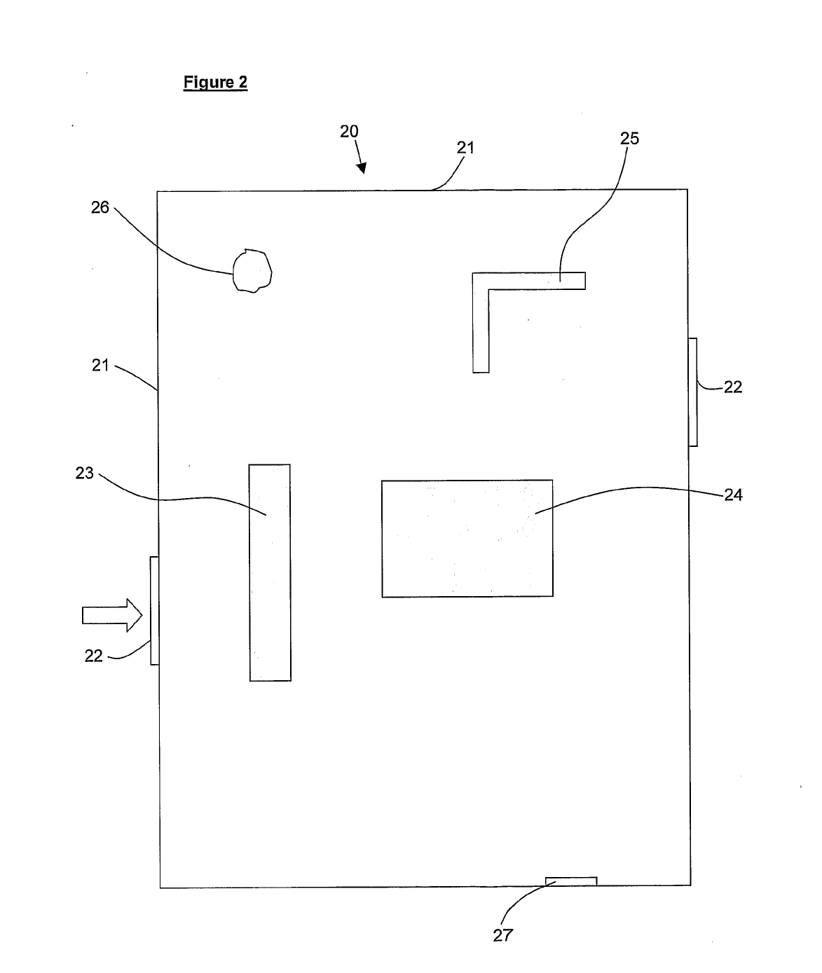

A schematic of a simple virtual world environment is shown in FIG. 2. This represents a room 20, including walls 21, doors 22, and various obstacles 23, 24 and 25 within the room. When specifying the design of this virtual world 20, the content provider inputs data in the form of co-ordinates representing the shape of the environment into the server 2 via terminal 3. The data might include co-ordinates representing a collisionable mesh defining the obstacles 23, 24, and 25 through which a navigating user is not allowed to pass.

Feature Nodes

The content provider is able to define features of interest within the room that a user may wish to view. For example, if the virtual world represents a tour through a historic building, it may be desirable to insert features such as statues, furniture, paintings and information boards. These may be represented by objects within the room, for example statue object 26, painting 27, and information boards (obstacle 25).

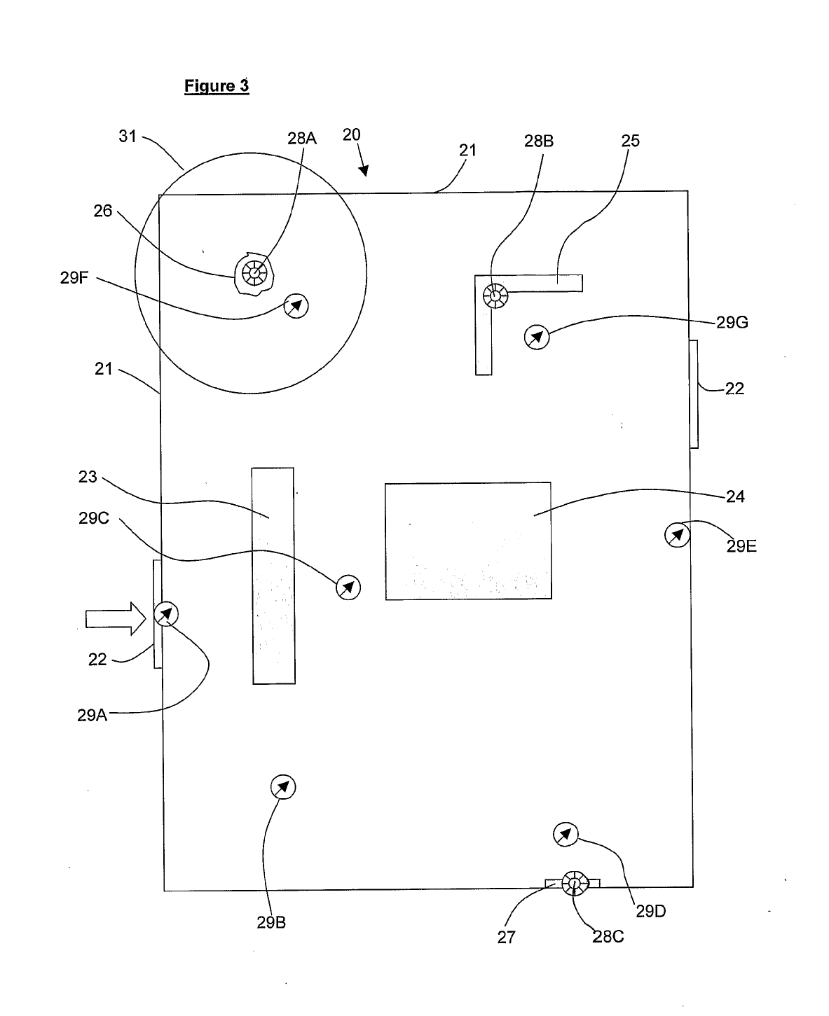

In order that these features may be visited by a user, the content provider defines feature nodes 28A, 28B and 28C (shown in FIG. 3) associated with the features, which the user can view or interact with. A feature node is therefore essentially a point in the virtual world, linked either to an object or to the collisionable mesh, and in the embodiment has the following data set:

Node ID
Feature Group ID
Object ID of the linked mesh/object
XYZ of object pivot point data
Sphere of influence settings
Display settings

Node ID—an unique identifier for the node (e.g. text string “monet_painting_{—}01” or numerical identifier “00563”)

Feature Group ID—an identifier for the type of feature associated with the node, for example all paintings may be in a first Feature Group identified as “paintings”, whilst information boards might be a second Feature Group “information_points”. The choice of groupings is highly dependent on the content provider and the type of features they wish to distinguish within the virtual world.

Object ID of linked mesh/object—this is the identifier for the object or collisionable mesh associated with the feature node, and may be the same as the node ID (e.g. “monet_painting_{—}01”)

XYZ of Object Pivot Point Data—these are the co-ordinates giving the location of the feature node (and may be obtained by extraction from properties of the object/mesh with which the feature node is associated)

Sphere of influence settings—these define (for a 3D world) a three dimensional sphere (for example, illustrated as circle 31 in FIG. 3) surrounding the feature node, and are used during the calculation of navigation paths through the virtual world

Display settings—these are some of the settings to be used for text/images associated with the feature

Navigational Nodes

The content provider also initially defines a plurality of navigational nodes (29A, 29B, 29C, etc) within the virtual world, as shown in FIG. 3. Essentially, these provide a simple matrix of navigational points which the automated path generation algorithm can use to plot a route through the environment. Associated with each navigational node is the following data set:

Node ID
Node Level ID (optional)
XYZ position
LoS data
LoS constraint settings (optional)
FoV constraint settings (optional)
Orientation constraint settings (optional)

Node ID—a unique identifier for the node

Node Level ID—this is an identifier which allows a level for the node to be defined, effectively grouping the nodes into different subsets, and used during the path finding process to split the virtual world into different regions for processing efficiency. For example, two different rooms in the virtual world could be represented by different regions of nodes, with the doorway between them comprising a switch node. For processing efficiency, a path can initially be calculated based on only the nodes of one of the rooms (thus saving erroneously calculating at this stage paths which enter the second room, and only later allowing the pathfinding calculation to extend to the second room via the switch node). Additionally it is possible that the different sub-sets could cover overlapping regions (for example a first level of nodes might provide coarse coverage of a large area while different levels might provide finer coverage of the same area or subsets of that area).

XYZ position—these are the x, y, z co-ordinates giving the location of the navigational node

LoS data—this data field will be empty initially, but is later used to contain a list of all nodes which the present node has Line of Sight (LoS) to, i.e. all the nodes that it is able to link to (see later for further details)

LoS constraint settings—the content producer may choose to manually define an angular LoS constraint (e.g. an angle range, in which the node is only allowed to search for nodes to link to if they fall within that viewing angle, see later for more details)

FoV constraint settings—the content producer may choose to define angular constraints for the Field of View (FoV) which will constrain the range of images allowed to be displayed to a user at that node (e.g. for node 29F, the FoV may be constrained in the angular direction towards statue object 28A to ensure that the user sees the object)

Orientation constraint settings—for some navigational nodes, the content producer may choose to constrain the allowed orientation of the user as they approach the node, by defining orientation constraint settings this forces the calculated path to approach the node from a particular direction.

The content provider is thus able, through the use of navigational nodes, to define key positions within the virtual world from which the potential user is able to best experience the features of interest within the environment. The content provider can define the exact position, direction of approach (orientation settings), and viewing angle (FoV constraint settings) so as to increase the quality of the user's experience of the features of interest, compared with other systems which are completely automated.

Processing

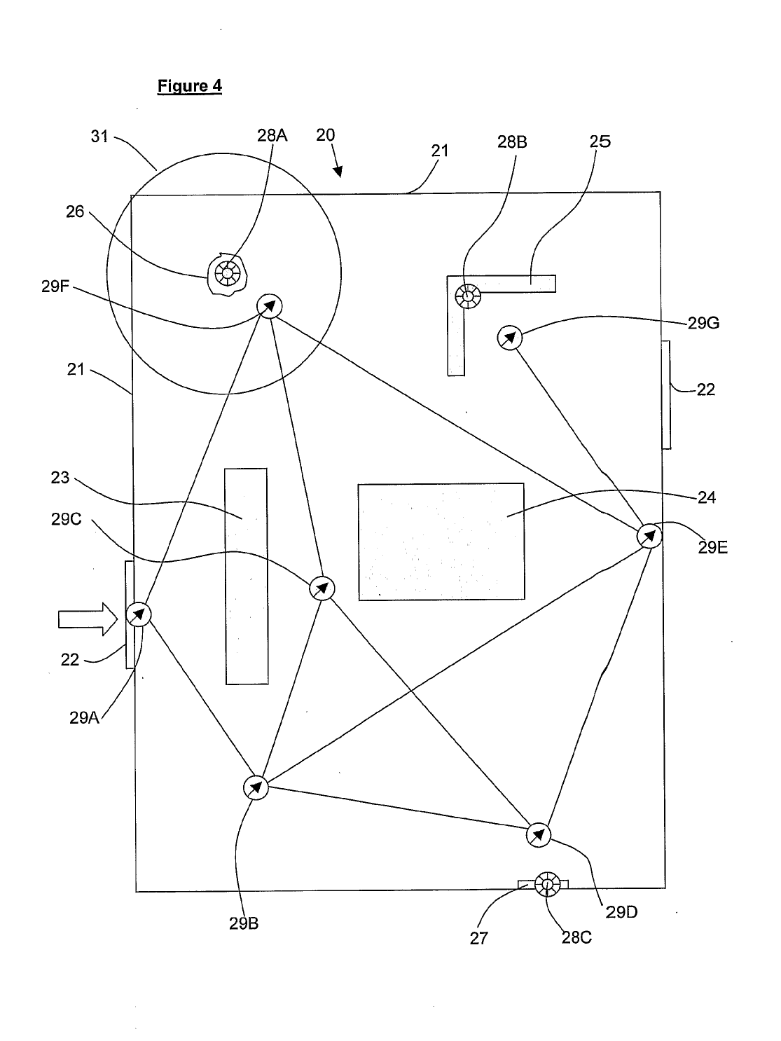

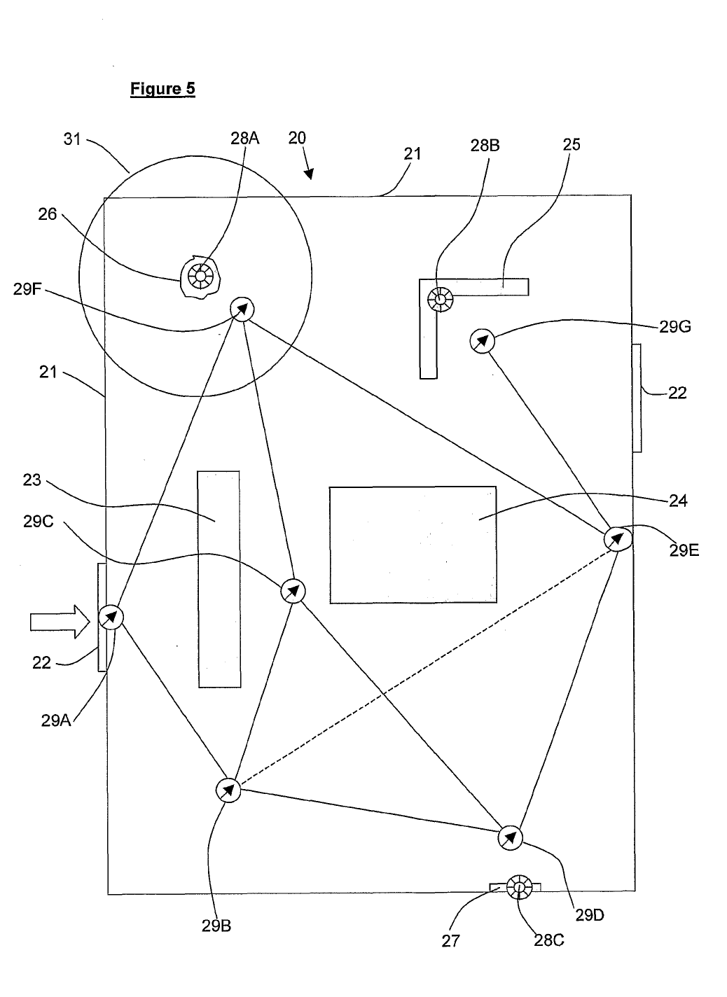

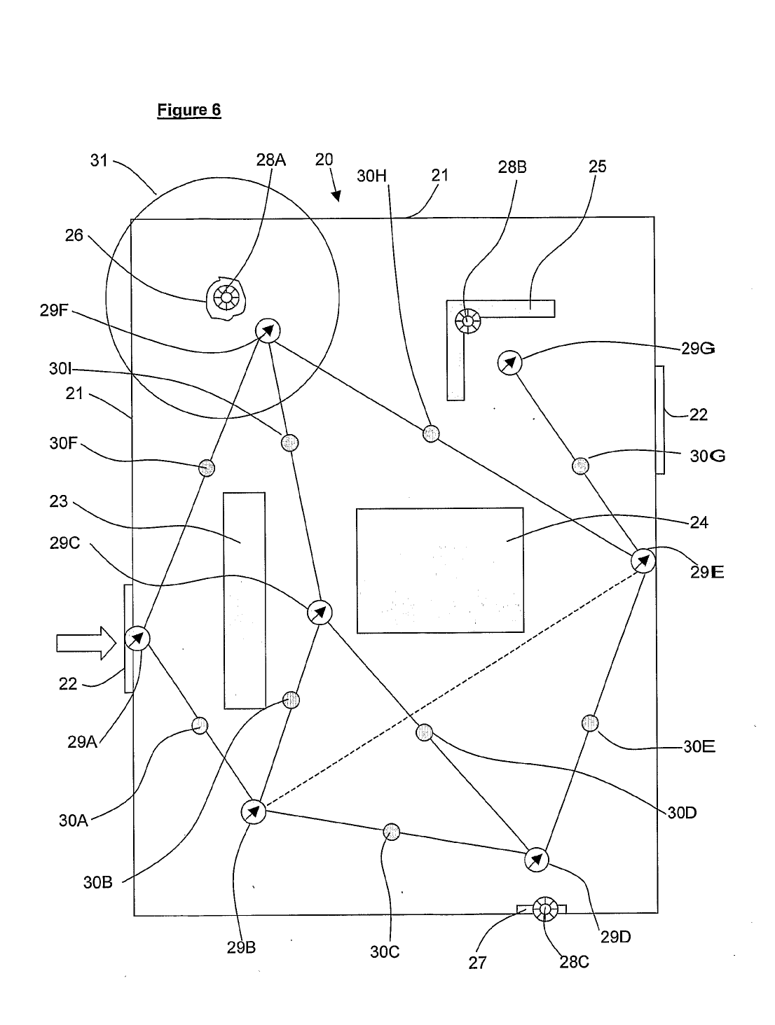

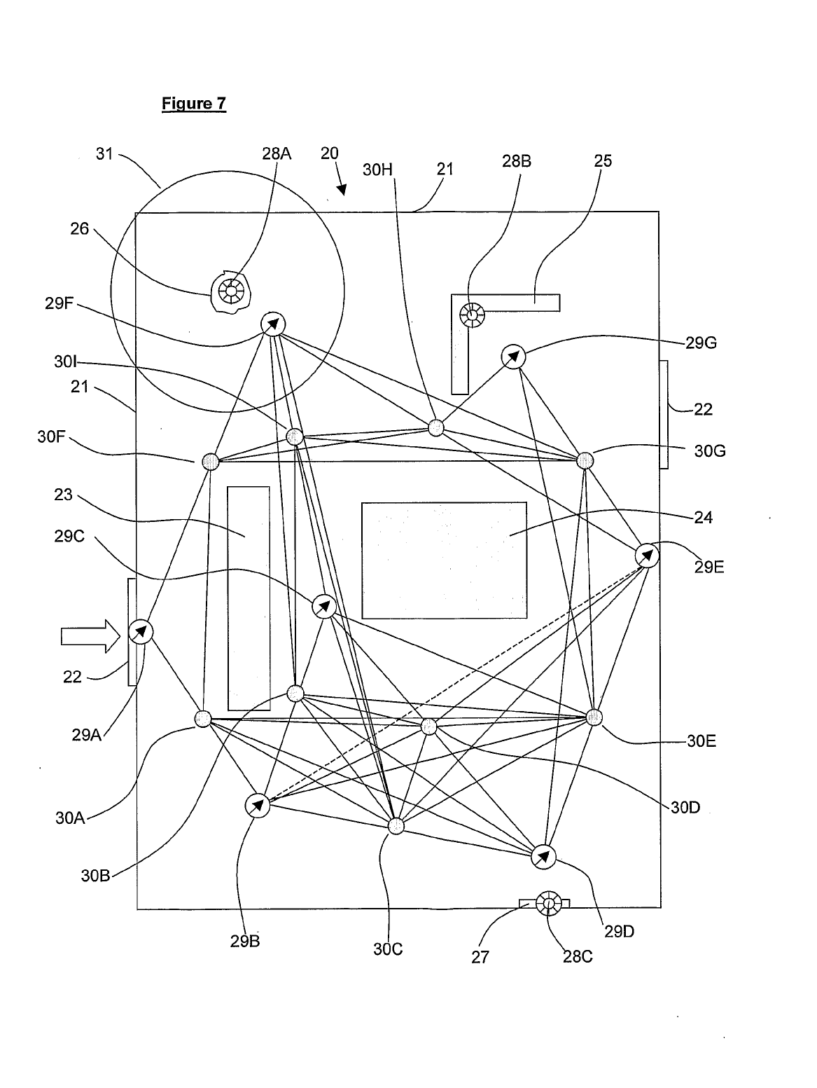

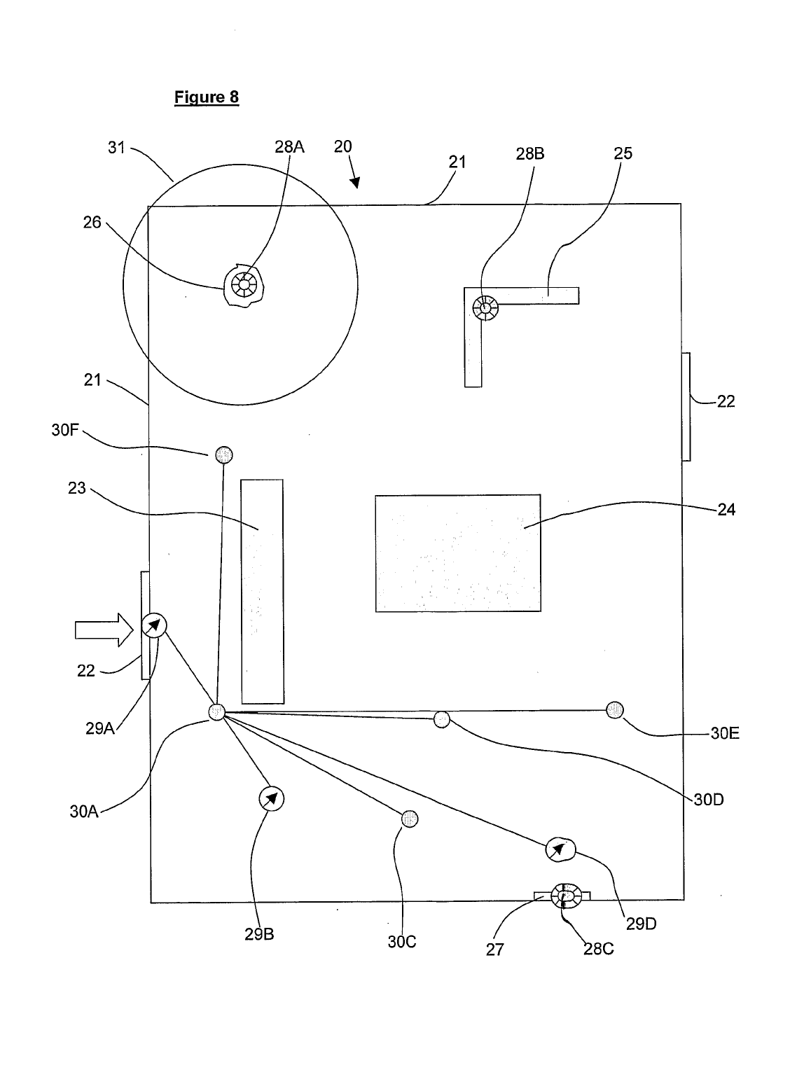

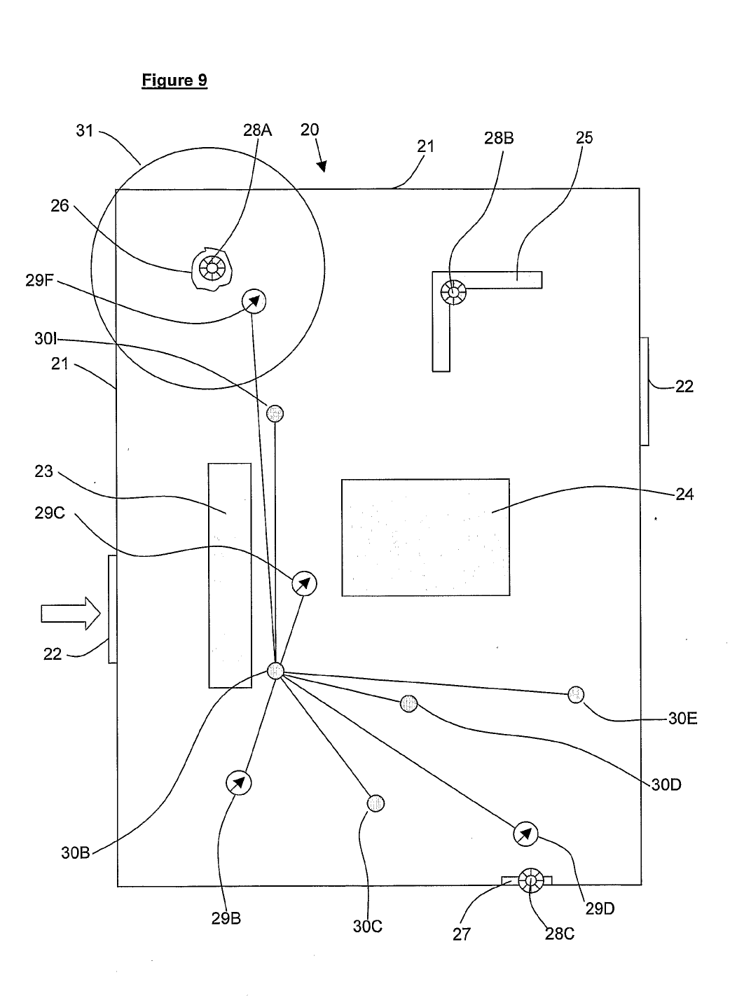

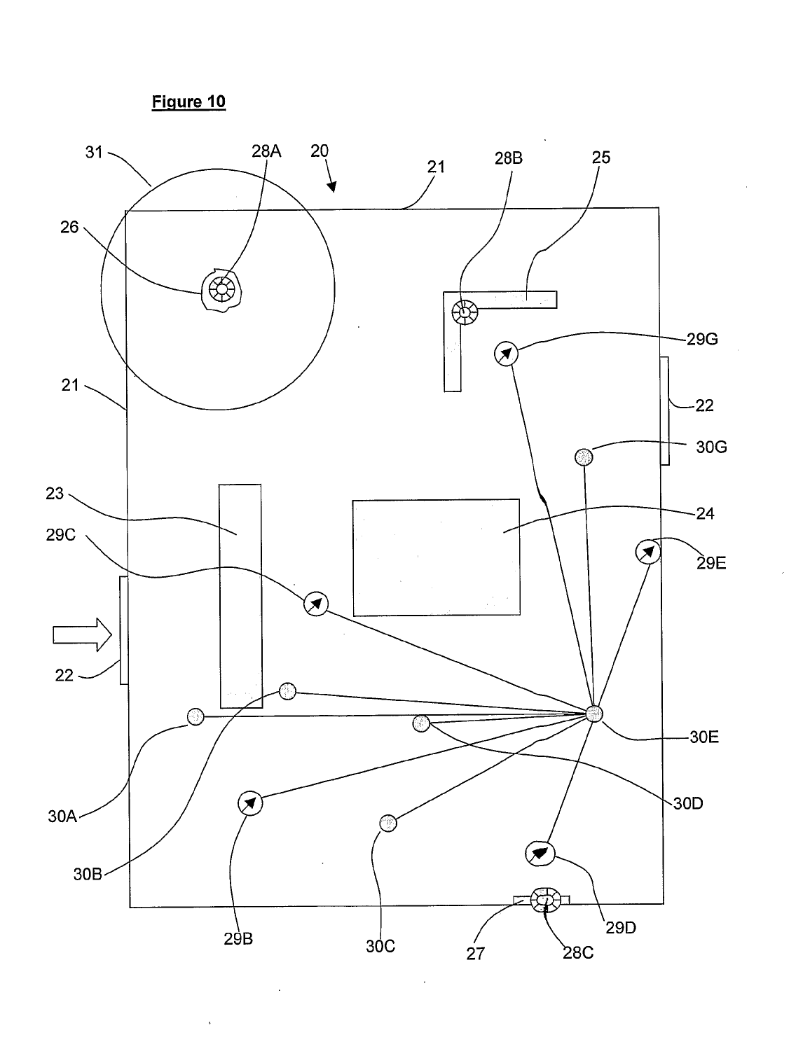

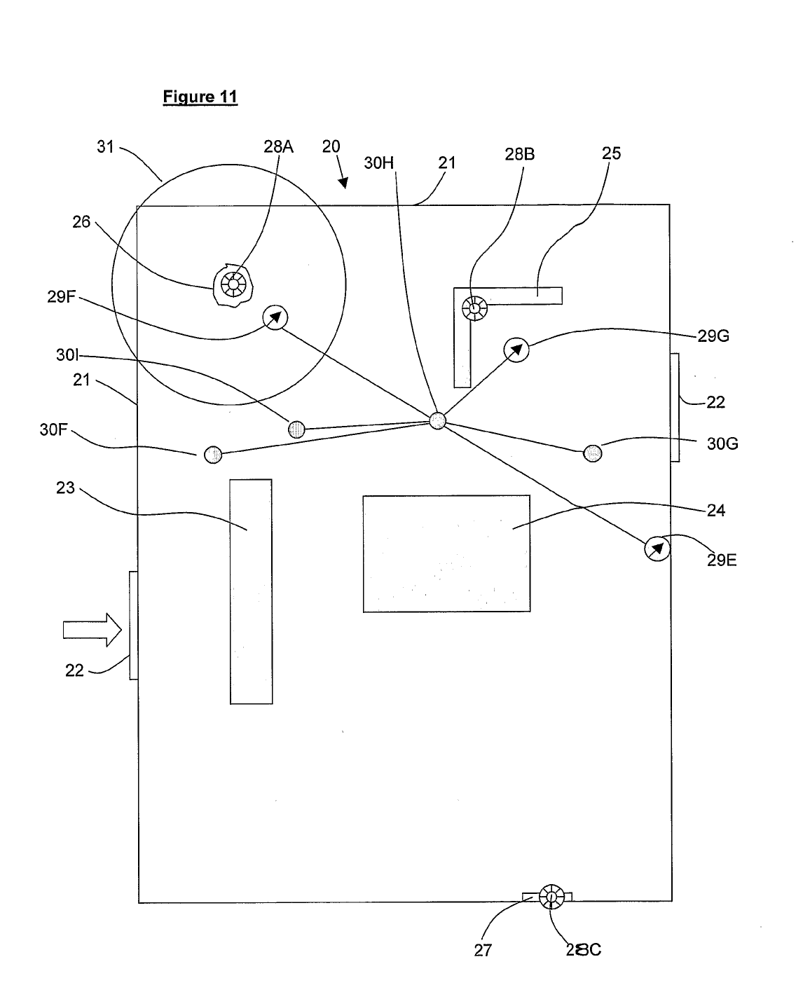

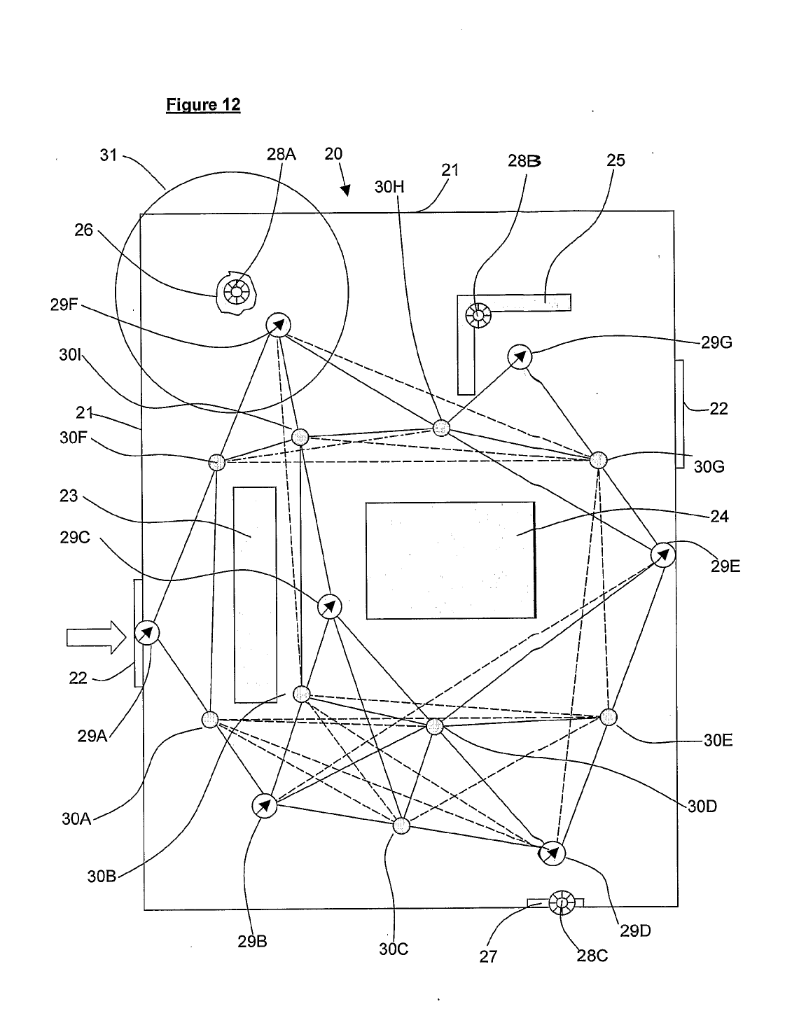

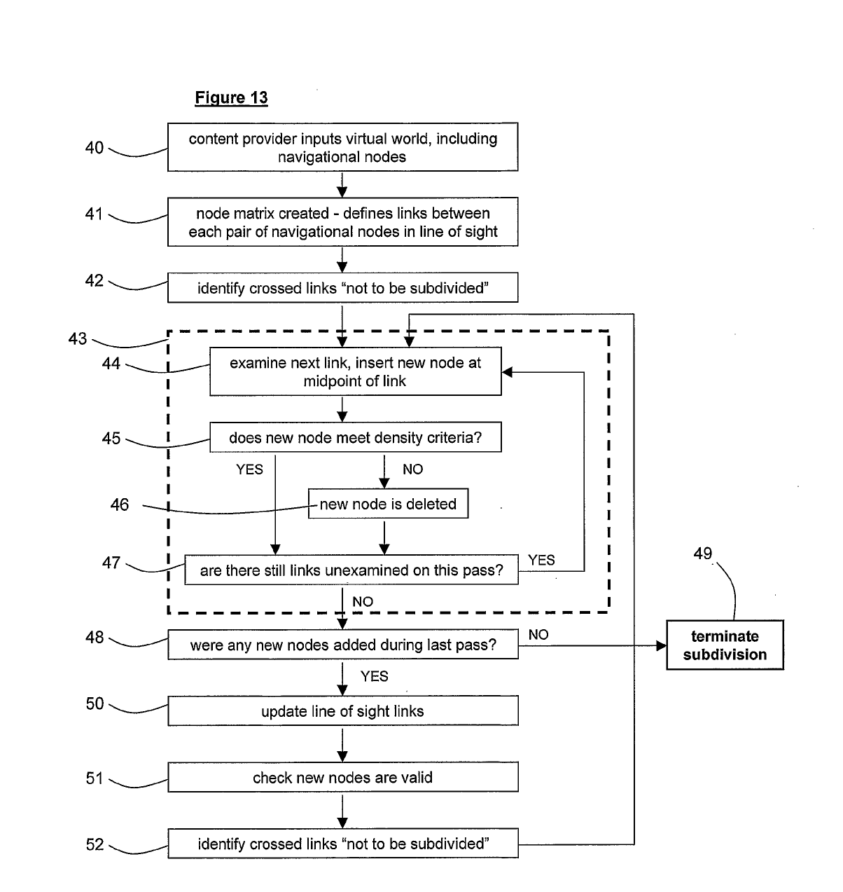

The subsequent processing is explained with reference to the flow diagram in FIG. 13. After node data has been input to the system (step 40), a node matrix is automatically created for the virtual world (step 41). This identifies for each navigational node all the other navigational nodes it is able to link to. Node links are calculated following basic rules of LoS (line of sight) for two nodes. This takes into account the collisionable mesh and any other objects deemed to crop the LoS of the nodes (i.e. no links are allowed to pass through obstructions because a path between nodes cannot pass through these). FIG. 4 illustrates all possible LoS links for navigational nodes in the virtual world 20 (i.e. the lines linking nodes 29A, 29B, etc). For example, Node 29A has direct line of sight to both nodes 29B and 29F, but not to 29C because this would pass through the obstacle 23. A node matrix for virtual world 20 of FIG. 4 is represented in tabular form below:

| Node | Links to other nodes |
|---|---|
| 29A | 29B, 29F |
| 29B | 29A, 29C, 29D, 29E |
| 29C | 29B, 29D, 29F |
| 29D | 29B, 29C, 29E |
| 29E | 29B, 29D, 29F, 29G |
| 29F | 29A, 29C, 29E |
| 29G | 29E |

At this stage each navigational node's data set is provided with LoS data on all its visible partners, including their XYZ position. Any navigational node which does not have line of sight to any other navigational nodes is deemed invalid and may be deleted from the system.

If the content provider had specified any LoS constraints for particular navigational nodes, then this would crop the angle it is allowed to search for node links. This is controlled using “LoS constraint settings” for the node, comprising degree values which slice the otherwise allowed 360 degree LoS. In this case, the node matrix above would differ as some of the links shown there would not be allowed. This functionality allows the content provider to create channels of nodes that ignore other nodes around them, and to produce breaks in the node matrix where nodes are not desired. This can improve the user experience because in this manner the content provider can influence the routes taken by a user within the virtual world.

The next stages of processing will add in additional nodes on the basis of the LoS links already defined. However, before that occurs, the system checks all the links (step 42) to decide which links will/will not be used as a base for the new nodes. In particular, the system looks for any crossed links (such as the 29B-29E link which crosses the 29C-29D link), and marks the longest of the crossed links as not being available for use as a base for the new nodes. In this embodiment a data flag is associated with the link (in either the node matrix or the individual nodes' LoS link data) to indicate that this link is “not to be subdivided”. The affected link is shown as a dotted line in FIG. 5.

The next stage of processing involves the automatic creation of a more dense matrix of nodes (step 43). This is achieved by subdividing the LoS links between the existing navigational nodes so as to add new navigational nodes (also referred to as subdivided nodes) at each midpoint (step 44). FIG. 6 shows these subdivided nodes (30A, 30B, 30C, . . . etc). As more and more new nodes are added during each cycle through step 43, the density of nodes increases, up to a maximum allowed node density. This density may be predefined in advance by the content provider, for example by specifying a minimum allowed distance from a node to it's nearest neighbor. After each new node is added, the system checks whether the new node meets the density criteria (step 45). If it falls outside the allowed density criteria, the new node is deleted (step 46). Otherwise, the node is kept. Once every LoS link has been examined for subdivision (step 47), the system checks whether any new nodes were added during the last pass (step 48). If no new nodes were created during a pass, the system terminates (step 49).

For each pass, after the new nodes have been added, the LoS data for every node (both the navigational nodes and each newly created subdivided node) is updated to take account of all the multiple new possible LoS links (step 50). FIG. 7 illustrates the newly created dense matrix with many more possible LoS links between the nodes.

The system now checks which of the newly added nodes are valid (step 51). A node is defined as valid if it links any two other nodes which do not otherwise have line of sight to each other. This is illustrated for node 30A in FIG. 8. In this drawing, for clarity, the only nodes and links illustrated are node 30A and the seven other nodes it links to. It can clearly be seen that node 30A acts as a bridge for many different pairs of nodes (i.e. it forms a connection between two nodes which do not have LoS to each other), such as between nodes 29B and 30F. Therefore node 30A is valid, and in fact only requires that it is connected to one pair of nodes which do not have LoS, to be defined as a valid node. Any invalid nodes are deleted.

FIG. 9 shows the same procedure for node 30B. Node 30B is defined as valid. However at this stage, any of 30Bs links which do not assist in bridging between two nodes are deleted. This is the case for the link between node 30B and 29C Since node 29C already has line of sight links to all the nodes shown on FIG. 9 (and reciprocally node 30B also has line of sight to all the nodes linked to 29C), therefore link 30B-29C cannot help to bridge between any pair of nodes that do not have line of sight to each other, and the link 30B-29C is deleted.

Link 30B-30C would also appear from FIG. 9 to be redundant, because node 30C already has line of sight to all the nodes in FIG. 9. However, link 30B-30C is actually valid because it bridges, for example, nodes 30B and 30A (which do not have line of sight to each other) which can be seen from FIG. 7, and therefore link 30B-30C would not be deleted.

Validity checks are carried out in this manner for all new nodes, and two others (30E and 30H) are shown, in FIGS. 10 and 11 respectively.

After the validity checks have been performed on the new nodes, the system again checks for any crossed links (step 52). These are the links which are not to be used in any subsequent cycles of subdivision. The links are identified as before, by looking for links which cross each other and flagging the longest ones as “not to be subdivided”. This has been performed for all the links, and the resulting link matrix is illustrated in FIG. 12 (where dotted lines illustrate those links which are not to be used in the future for subdivisions to add more nodes).

Thus one cycle of subdivision has been completed, and even after this, the number of nodes has more than doubled, and the connectivity between the nodes has greatly increased. For example node 29D previously only had links to 29B, 29C and 29E, but is now additionally linked to 30B, 30C, 30E and 30F.

Further cycles of subdivision (step 43) may be repeated, until the system has created a suitably dense matrix of nodes which map out the non-collisionable environment in the virtual world. Advantageously, during the subsequent pathfinding calculation, there is no need to calculate collision data in real time because the matrix nodes are all constrained to navigable areas. In addition, with the higher density of nodes in the environment, the system can generate far more efficient paths than with the originally defined node matrix, and which enhance the user experience by giving a much smoother path through the virtual world which typically follows the type of behavior a user is used to when navigating a real world environment.

Once the path has been calculated a spline is generated to further interpolate and hence to smooth the journey still further. In the present embodiment, once the spline has been generated along a particular path, a default speed along the path is set. In the present embodiment this is set to vary between a fairly fast speed in areas of little interest and to a relatively lower speed around features of interest. Ideally this is done by smoothly varying the speed to have minimum values at the feature nodes of most interest and to have maximum speeds in between these points.

Although in the embodiment above, the node density criteria is specified in terms of the minimum allowed distance between a new node and an already existing node, this could be replaced by any other suitable mechanism for specifying and testing the node density. Another possible method is to specify in advance a maximum allowed number of cycles of subdivision before the algorithm must terminate.

Although In the embodiment above, the check for whether a new node is valid involves checking whether the node acts as a bridge between two other nodes, an alternative/additional criteria which may be used to define whether each newly added node is valid is to check whether the new node assists in providing a shorter path between any pair of nodes.

Pathfinding

As mentioned earlier, the A* algorithm is an optimal pathfinding algorithm both in terms of the processing time required, and the quality of the path found. Start and destination nodes are defined in advance, and the algorithm explores multiple different paths to find the best route from the start to the destination. Consider the case of a user who wishes to tour through virtual world 20, entering at door 22, and who has indicated via a suitable interface that he desires to approach information board 25.

The start node is defined as node 29A, and the destination nod e as 29G. The A* algorithm operates by maintaining two lists of nodes: a list of nodes that have already been explored (the Closed list) and a list of nodes linked to the ones that have been explored but have yet to be explored themselves (the Open list). The algorithm takes a node from the Open list, and if it is the destination node then the algorithm terminates. If not, all the nodes linked to the chosen node are added to the Open list. The A* algorithm is known as a heuristic method because it uses estimates to guide the search for nodes. In particular, in order to decide which node should be selected next from the Open list, all the nodes have an evaluation function f=cost+heuristic, and the node which is selected as the next current node from the Open list is the one with the lowest value for f.

The cost is a measure of the quality of the path so far from the start node to the current node (i.e. for a simple A* algorithm this could be the sum of the lengths of all the links in the path between the start node and the node). The heuristic function is an estimate of the cost to get from the current node to the destination node. The results of the A* algorithm are very much dependent on the choice of cost and heuristic functions, and it is the specific weighting and cost values used in the evaluation function for the embodiment of the invention that allow the optimum path to be generated.

The cost function of the embodiment takes into account various factors of the route, together with any user specific preferences. The cost function is a weighted sum of the following form:
cost=w1*distance+interest_component+w3*angle
where distance is length of the links so far, and w1 is the weighting ascribed to the current user indicating how important it is to them that the path is as short as possible. Interest_component gives a measure of how interesting the node(s) so far have been (but since we are looking to minimize the cost function, the lower the interest_component value the more interesting the nodes so far have been). Thus, in the present embodiment a summation over the node or nodes included in the partial path built thus far of the form:

$${\sum }_{PARTIAL\_PATH} ( 1 - w 2 * Interest )$$

is used, in which w2 is the percentage weighting interest given to the feature group associated with the node in question, and Interest is a measure of how strongly a node is associated with the corresponding feature associated with the node. Thus, in the present embodiment, feature nodes (typically of great interest to a user) may be given an Interest value 1, whilst navigational nodes have interest value of 0 and therefore when summed as above give a higher cost. As mentioned, weighting w2 gives a measure of how important it is to the user that they visit features of interest of each respective feature group.

Finally, angle gives a measure of how much the path so far wiggles, since this represents a sum (or average) of how much the angle between the entry and exit links for each node deviates from a straight line. Weighting w3 gives a measure of how important it is for the user that the path wiggles as little as possible (i.e. a zero value of w3 would suggest that the user did not mind how wiggledy the path was whilst a high value (eg 100%) would indicate that the user would prefer to avoid wiggly paths).

The heuristic is an estimate of the cost to get from the current node to the destination node, and one possible choice for this is:
heuristic=euclidian_distance_to_destination

The heuristic in the embodiment is therefore based on the Euclidian distance to destination (i.e. a straight line from the current node to the destination node), although it could alternatively also include some measure of the distance, interest and angle weightings w1, w2 and w3 if desired.

The system therefore runs through the A* algorithm for the nodes using the evaluation function, until the final destination node is reached. Importantly, the weightings w1, w2, and w3 can be varied depending on the user profile.

Defining a User Profile

A suitable interface (not shown) allows the user to define their profile (e.g. what they are particularly interested in, and how they like to navigate through the virtual world). The user profile settings are then incorporated into the weightings above used for the A* algorithm, which consequently will result in different paths being generated for different users. The translation of the user interests into weightings allow different routes to be compared against each other such that the optimum path for that user can be generated. It can be seen that for a user who is particularly interested in visiting features of interest (paintings, landmarks, etc) it is likely to be the case that the system will not calculate the quickest or shortest route between two points. Rather, the lowest cost path (i.e. the best route for that user) will be one which visits as many features of interest as possible.

The user may input their profile upon first entering the virtual world. Some options include:

| | |
|---|---|
| Always select shortest path | on/off |
| Always select quickest path | on/off |
| Ignore all features | on/off |
| Gaze orientation | on/off |
| Velocity control | on/off |
| Importance of path being short (w1) | weighting |
| Importance of path not being wiggly (w3) | weighting |
| Importance of visiting Feature Group 1 | weighting |
| [e.g. paintings] (w2) | |
| Importance of visiting Feature Group 2 | weighting |
| [e.g. information points] (w2) | |
| Importance of visiting Feature Group 3 | weighting |
| [e.g. landmarks] (w2) | |

The first five options are overrides, and are thus non-weighted. For example, if the user selected “Always select shortest path” as ON, then the weighting w2 for the features of interest become irrelevant and will be set to zero.

The final five options are all weighted, and however the weightings are distributed they should all be normalized (e.g. add up to 100% in total). Any option which is not important to the user and not given a weighting is deemed irrelevant and not taken into account in the pathfinding process.

Dynamic Navigational Nodes

In addition to the fixed navigational nodes (29A, 29B, 29C, etc), defined initially by the content provider, the system may also include dynamic navigational nodes (not shown). These nodes operate like navigational nodes in the sense that they can form part of the path generated for the user, but provide enhanced functionality because the user is able to move them. A dynamic navigational node is associated with an interactive mesh object in the virtual world environment that can be moved around by the user. The user is able to specify that they want the dynamic navigational node to be a destination point, and the path will be calculated to it's location.

If a dynamic navigational node is placed a large distance from other navigational nodes, then the subdivision process described earlier may be used to fill in new nodes until a suitable node density is achieved in that area. This then allows a smooth path to be calculated to the node.

If a dynamic navigational node is placed without a line of sight to any other navigational nodes (i.e. in a blind spot) then the node is defined as invalid—lost from the Node Matrix (although still present in the environment) and the user is prevented from selecting it as a destination. Alternatively, the system may prevent the user from placing the node in a blind spot, and only allows it to be moved into valid positions.

Switch Navigational Nodes

In addition to the fixed navigational nodes and the dynamic navigational nodes, the system may also include switch navigational nodes (not shown), defined by the content producer. As mentioned earlier, navigational nodes have a Level ID, specifying which level the node belongs to, and effectively grouping the nodes into different subsets for more efficient path calculation. For example, if the virtual world consists of two different rooms, then the navigational nodes in one room may be defined as belonging to one level, and the navigational nodes in the second room to a different level. During the pathfinding process in one room, only the nodes of that level are evaluated, saving takes into account nodes on a different level. The switch nodes then provide the functionality to swap from one level to the second level (e.g. the switch navigational node might be positioned in a doorway between the two rooms).

Associated with each switch navigational node is the following data set:

Node ID
Node Level ID #1
Node Level ID #2
XYZ position
LoS data
Switching data

Node ID-an identifier for the node

Node Level ID #1-the identifier for the first level

Node Level ID #2-the identifier for the second level

XYZ position-these are the x, y, z co-ordinates giving the location of the switch navigational node

LoS data-this gives the data for all nodes (for both levels) which the present node has Line of Sight (LoS) to

Switching data-gives the criteria of when the generated path can/cannot switch from navigational nodes on one level to nodes on the other level

Event Feature Nodes

As described earlier, the content provider is able to define feature nodes (28A, 28B, 28C, etc) associated with the features of interest in a virtual world. The content producer is also able to define event feature nodes (not shown) which have the extra functionality that they react to users within the virtual world, or are only active at certain predefined times.

These event feature nodes expand the functionality of the system into the gaming and interactive online environment platforms, where multiple users can interact with the environment and with each other (e.g. the Event Feature may simulate an explosion, or the opening and closing of an interactive chat-room/race event. The content provider must specify when the event feature will be active/inactive, or what triggers it will respond to. An example data set is as follows:

Node ID
Feature Group ID
Trigger data
XYZ of pivot point data
Sphere of influence settings
Time settings
Display settings

Node ID—an identifier for the node (e.g. text string “explosion”)

Feature Group ID—an identifier for the type of feature associated with the node

Trigger data—the conditions which will cause the event feature node to become active

XYZ of Pivot Point Data—these are the co-ordinates giving the location of the event feature node

Sphere of influence settings—these define (for a 3D world) a three dimensional sphere surrounding the feature node. However, in addition to the settings used for the standard feature nodes, these additionally include a time dependant feature which may allow the sphere of influence to degrade over time.

Time settings—these define when the event feature node will be active/inactive

Display settings—these are the settings to be used for text/images associated with the feature when constrained

Further Functionality

As explained above, the processing and pathfinding stages result in a spline path which will be used to take the user through the environment. The spline path therefore comprises a plurality of nodes each joined by links to the next node. The system applies smoothing to this path by interpolating the spline so as to improve further the user experience.

During real time display, when the user is guided through the environment they have the further option to control their field of view. As discussed earlier, the content provider can specify particular angles of viewing (FoV constraints) which are to be applied for specific feature nodes so as to ensure the user does not miss features of interest. The user can choose to toggle control to either operate this automatic field of view presentation or alternatively to control manually their own field of view.

In the embodiments described above, it is explained that the processing stage which creates the more dense matrix of nodes occurs after the content provider has defined the contents within a virtual world, but before the system is used by a user desiring to navigate within that world. It is of course alternatively possible for either part or all of the processing stage which adds these subdivided nodes to be carried out in real time whilst the system is in use by a user. Indeed, an alternative arrangement is particularly desirable when the virtual world contains a number of dynamically moving objects (for example, a virtual environment of a city might include moving cars, buses, etc). In this dynamic case, only some subdivision (for the static objects such as buildings, etc) could be carried out in advance before a user accesses the system, with the remaining processing to add the extra nodes occurring each time a user specified that they desire a path to be created. The processing stage thus takes into account the positions of these dynamic objects at the instant the user desires the path to be created. This functionality could be supplemented by defining some regions in the world in which this subdivision will occur (for example, streets within a virtual city), and other regions in the world when the dynamic subdivision will not occur because they contain only stationary objects (for example, the insides of some buildings). This is a typical example when switch nodes (mentioned above) are used to delimit the different regions.

Furthermore, it may be necessary in real time to create new nodes corresponding to the start and destination points selected by a user for a path generation procedure. If nodes do not already exist at these locations then the system may be used to automatically create such nodes, and additionally use processing to add new subdivided nodes in only the regions close to the start and destination nodes so as to link them to the already existing node matrix.

The method of generating a new path to a destination node in a virtual environment comprising a plurality of nodes will now be described in which nodal information identifying one or more nodes associated with a previously created path to said destination node is processed to determine the new path. The processing may comprise simply updating the spheres of influence and/or the interest_component of one or more of the nodes associated the previous path and repeating the pathfinding process described hereinabove. Alternatively, more complex processing may be done to on said stored nodal information to determine the new path.

In particular, the new path may enable a user who was being navigated automatically along the previous path and who switched from an automatic navigation mode to a manual navigation mode to resume an automatic navigation mode to the destination of the previous path. This can be implemented using the above path finding system even where one or more nodes in the virtual environment are changing dynamically, including even if the destination node has moved. In one embodiment of the invention, a validation of the previous path is performed as this may no longer be valid in terms of LoS or other constraints due to changes in the position and/or characteristics of the nodes which were included on the previous path to the destination. This aspect of the invention to reuse previously stored nodal information will now be described in more detail with reference to FIGS. 14 to 22 of the accompanying drawings.

One embodiment of the invention comprises a method of generating a return path to a portion of a first path created from a start node to a destination node in a virtual environment. The first path can be created by any suitable path generation process in which the nodal topology of the virtual environment can be reconfigured dynamically to include additional navigational nodes at the point where a path is to start.

In FIGS. 14 to 17, steps are shown associated with a method of toggling between navigational modes (defined in this context to be equivalent to switching or changing navigational modes) within a virtual environment is shown according to a various embodiments of the invention.

The pathfinding system described herein above is used to generate a path from an initial origin to an initial destination (step 60) along which a user is navigated automatically (step 62). Whilst origin of the path may be co-located with a navigational node of the path-finding system, the path-finding system may automatically create a start navigational node at the point where the user requests to be automatically navigated to a destination. Similarly, whilst the destination may be located at a destination navigational node for the automatic path generation, if not, the pathfinding system will generate a destination navigational node where the user has defined the desired destination.

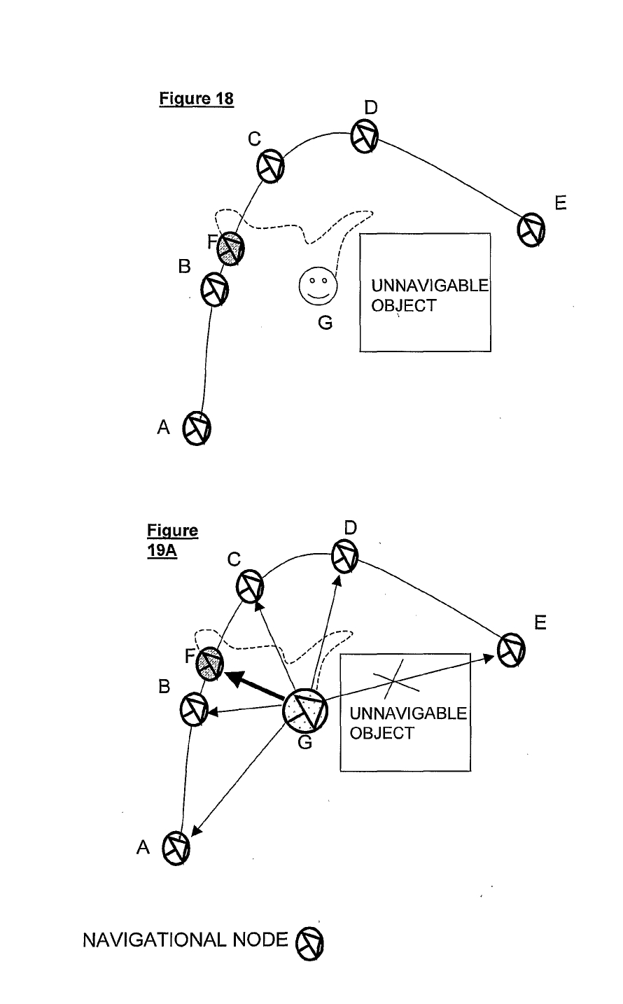

At a point along the path, the path becomes no longer actively navigated along. For example, a user activates a toggle to switch from the initial automatically navigated navigation mode to a manually navigated mode (step 64) in FIG. 14. This exit point may or may not be co-located with a navigational node of the path. In the embodiments shown in FIGS. 14 to 22, a new exit node F is created at the exit point as this lies between the nodes of the path. However, the exit point need not always coincide with a node of the path. In such circumstances, an exit node may be created, or alternatively, the node before or after the exit node on the path may be defined to be an exit node. FIG. 18 shows how a user navigating along a path from A to E may toggle off at an exit point between nodes B and C of the path.

Information relating to the nodes of the path is stored when the path becomes no longer actively navigated along. Thus the start node and destination node of the path are saved, together with information relating to any intermediate nodes. If a new exit node is defined/created, information regarding this is stored too. The user is then able to deviate at will from the path and explore using a manual navigation mode until they determine they want to resume an automatic navigation mode (step 66).

In the embodiment of the invention shown in FIGS. 14 to 17, the pathfinding system will seek to generate a new path to the destination node of the previous path which processes the stored nodal information of the original path when determining the new path. In FIGS. 14, 15, and 17, a return path to the guided path is determined according to one or more criteria to reduce the computational complexity associated with generating the new path to the destination.

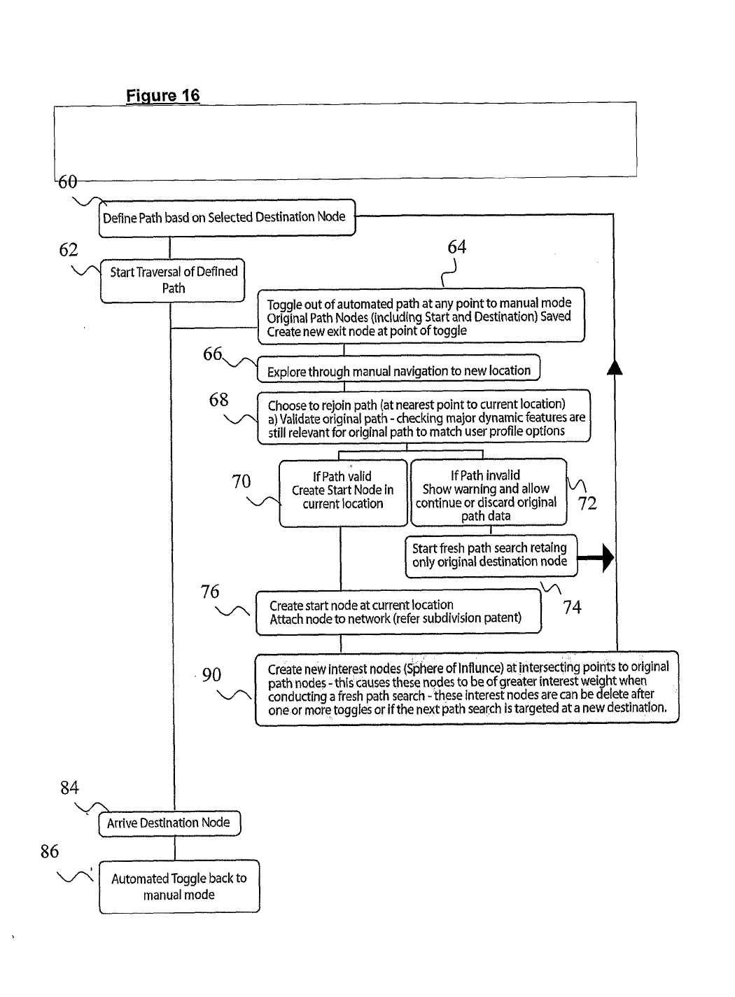

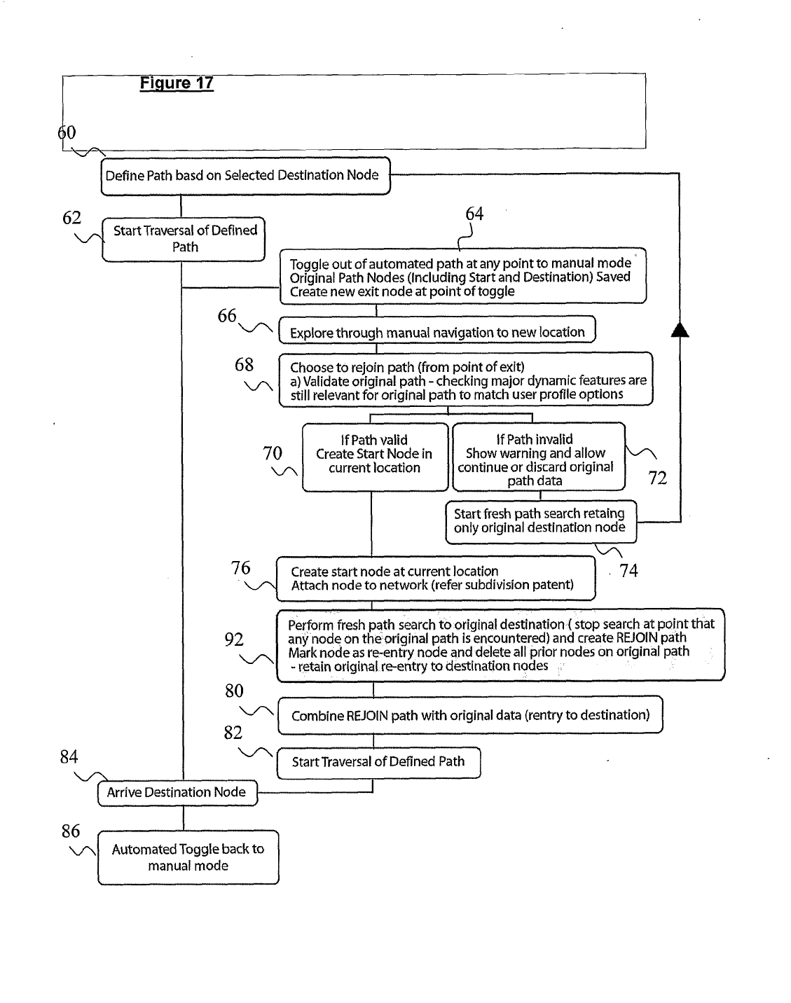

In FIG. 16, the nodal information stored is updated with an increased interest_component and a new pathfinding process is performed with this increased interest_component. This makes it more likely that the new path will intersect the original path. If the new path intersects the previously generated path, it is possible to reuse the stored nodal information to continue on to the destination. Alternatively, as FIG. 17 shows, it is possible for the new path to be completely independently regenerated to the destination, but by increasing the interest_component of the nodes associated with the previous path, it is more likely for the user to resume a path similar to the previously generated path. By reusing the nodal information associated with the previous path, the new path to the destination can be determined more quickly and efficiently, preventing the user from experiencing an undesirable delay before resuming the automated navigational mode. This is particularly advantageous when a path is being generated dynamically.

According to the invention, the path generated should be the optimal path permitted by the pathfinding system. This may be the shorted path back to the original guided path, but may not always be due to the possibility for the topology of the network of nodes defining the automated path system being capable of dynamically changing as a user progresses along a path.

Due to the potential for the network topology itself to evolve autonomously with the virtual environment, the original path is revalidated at the point where the user selects to toggle back to the automated navigation mode (step 68) to determine if the features of the original path are still relevant for the original path to match the user profile options.

If the original path is still valid, then a new start node is created at the toggle back point (the point where the user wishes to resume automated navigation) (step 70). However, if the path is invalid, then the original path data is discarded (step 72). In this latter case, a fresh path search retaining only the destination node is initiated (step 74). Alternatively, the user may be able to continue to rejoin the original path but a warning is displayed to indicate this is now no longer recommended (step 72).

If original path is still valid, the new start node created at the toggle back point, which is then attached to the network to be used to generate a return path using the pathfinding system described hereinabove.

In FIG. 14, the return path is generated by performing a parallel node search from the new start node to all nodes which are defined along the original path between the exit node to the destination node of the original path. These nodes need not be in the same position along the path when it was originally created, i.e., the actual topology of the original path may have evolved. It is also possible that certain new nodes may now exist along the originally guided path and/or for some of the nodes along the originally guided path to no longer exist. Thus if a node associated with a moving object having a high interest feature weighting or a large sphere of influence has moved, the original path may have changed accordingly. In one embodiment of the invention, once the nearest node along the original path has been determined, no other nodes along the original path are determined (step 78). This enables all nodes prior to the nearest node to be discarded, and only subsequent nodes which remain along the guided path to the destination remain.

A return path is then generated using the pathfinding system to the nearest node identified in step 78 and this is combined with the subsequent nodes remaining along the originally guided path to the destination (step 80)

Once the new guided path has been generated in step 80, the navigational system then automatically navigates the user along the new guided path towards the destination node (step 82). When the user reaches the destination node (step 84), the automatic navigation stops and the user resumes manual navigation (step 84).

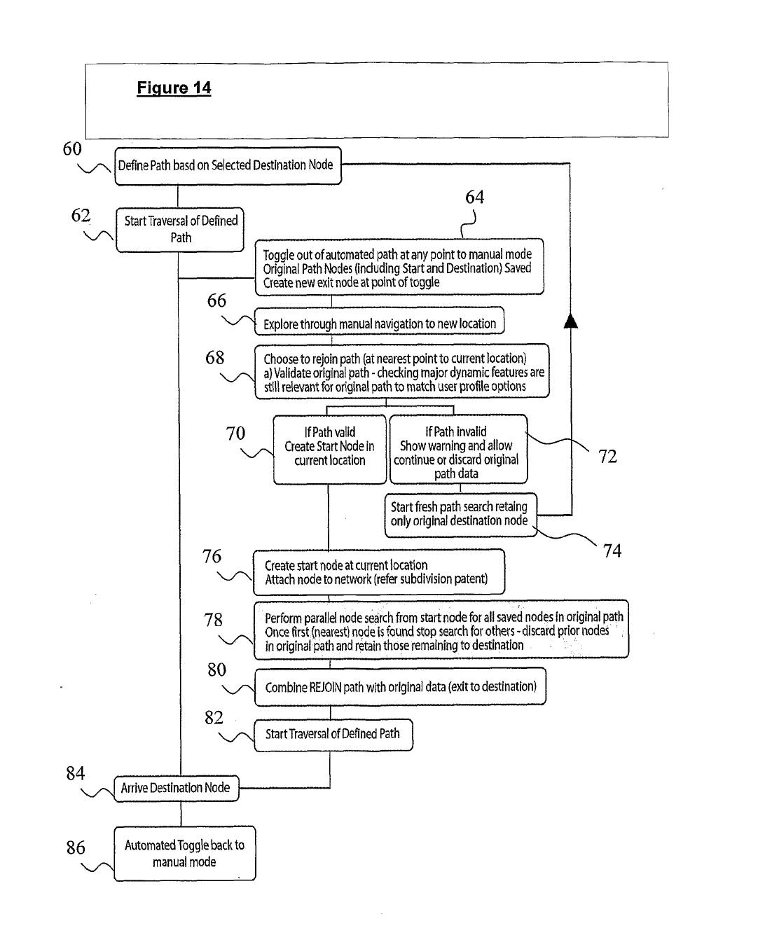

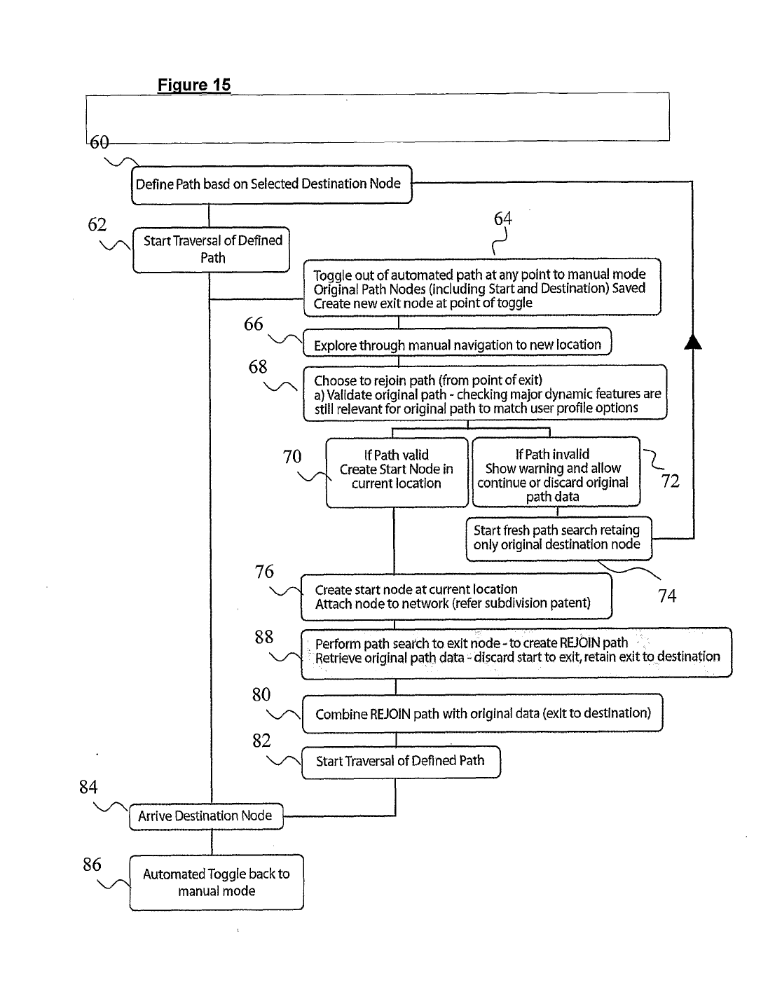

FIGS. 15, 16, and 17 retain the same numbering scheme used in FIG. 14 for equivalent steps in these different embodiments of the invention.

In FIG. 15, another embodiment of a method of toggling between navigational modes within a virtual environment is shown in which step 78 of FIG. 14 is replace by step 88.

According to the embodiment shown in FIG. 15, if the original path is still valid a new start node is attached to the network of nodes in an equivalent manner to described in step 76 in FIG. 14. However, the return path is generated by performing a path search to the exit node only of the original path. The remaining points along the original path data are retrieved, and all points prior to the exit node are discarded. This option may not be available if the exit node has an angle of entry associated with it, and the user has specified only relatively straight paths are to be generated with the virtual environment by imposing an angle differential constraint (for more details see the inventor's copending patent application, entitled “Pathfinding System”, a copy of which is filed herewith as Appendix II.

In FIG. 16, another embodiment of a method of toggling between navigational modes within a virtual environment is shown in which step 78 of FIG. 14 is replace by step 90.

In this embodiment, new interest nodes are created using the Sphere of Influence techniques described in Appendix II at intersecting points to the original path nodes. This results in these nodes having a higher interest weight when conducting a fresh path search (i.e, the interest_component increases). These interest nodes are deleted after one or more toggles have been activated by the user to switch between navigational modes, or if the next path search is targeted at a new destination. However, by increasing the interest_component the newly generated path is more likely to encounter the nodes of the previously generated path.

In FIG. 17, another embodiment of a method of toggling between navigational modes within a virtual environment is shown in which step 78 of FIG. 14 is replace by step 92, and a new return path is generated.

In FIG. 17, a fresh path search is performed to the original destination which is interrupted as soon as it encounters any node which lay on the original path. This node is then the re-entry node for the original path and all nodes which existed prior to the encountered node along the original path are deleted (step 92).

FIG. 18 shows an exemplary path from an origin A at which a start node has been created to destination E at which a destination node has been created. The path generated intersects navigational nodes A,B,C,D and E and circumvents an unnavigable object which prevents a more direct path from being generated from A to E.

In FIG. 18, the solid line indicates the guided path which is originally generated from A to E and along which the user was being automatically navigated. The dashed path represents the point along the guided path at which the user switched to manual navigation. Also shown in FIG. 18 is exit node F (indicated by the hatched node icon) which was created when the user switched to the manual navigation mode from the automated navigation mode. This is exit node was not part of the original guided path, although it forms part of the path created.

Also shown in FIG. 18 by the smiley face icon is the location G at which the user decides to resume automated navigation.

FIGS. 19A and 19B shows how the parallel path search feature of step 78 in FIG. 14 may generate a search for several paths in parallel to nodes of the guided path, including the exit node (Dan/Martin—is this true or does the exit node only come in with step 88 in FIG. 15). The closest node to the user is then determined and used to generate a re-entry point to the original guided path. In FIG. 19A, the nearest node is in fact the exit node F. However, in FIG. 19B, node D has moved and is now located closer to node F, and so node D is selected as the re-entry point. FIG. 19C shows how a return path (also referred to herein as a rejoin path) is generated between nodes G and D. The shaded navigational points in FIG. 19C are all deleted and the path continues to destination node E along the original guided path. Once this path has been determined, automatic navigation commences along from node G to node E via node D.

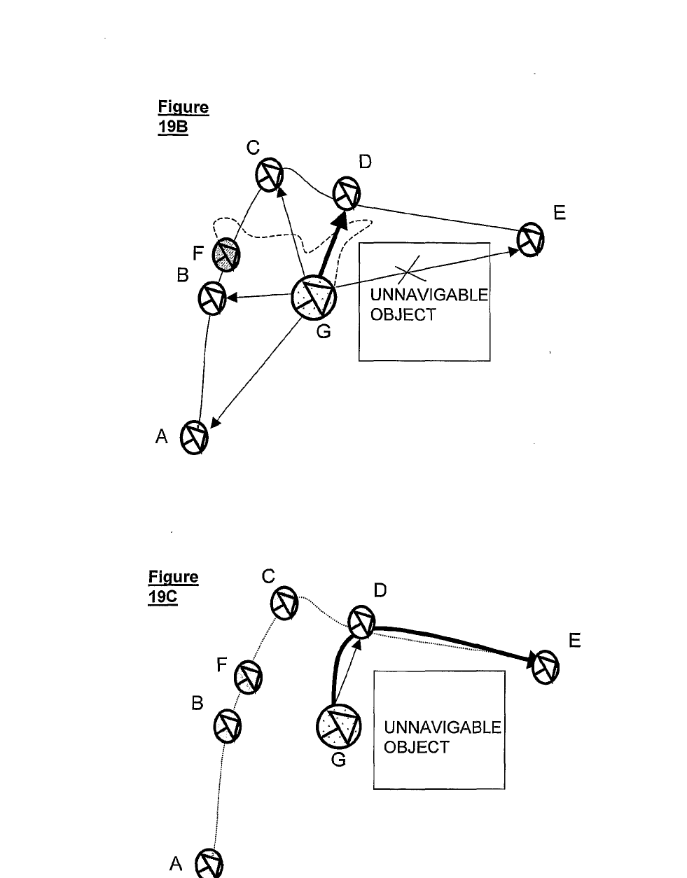

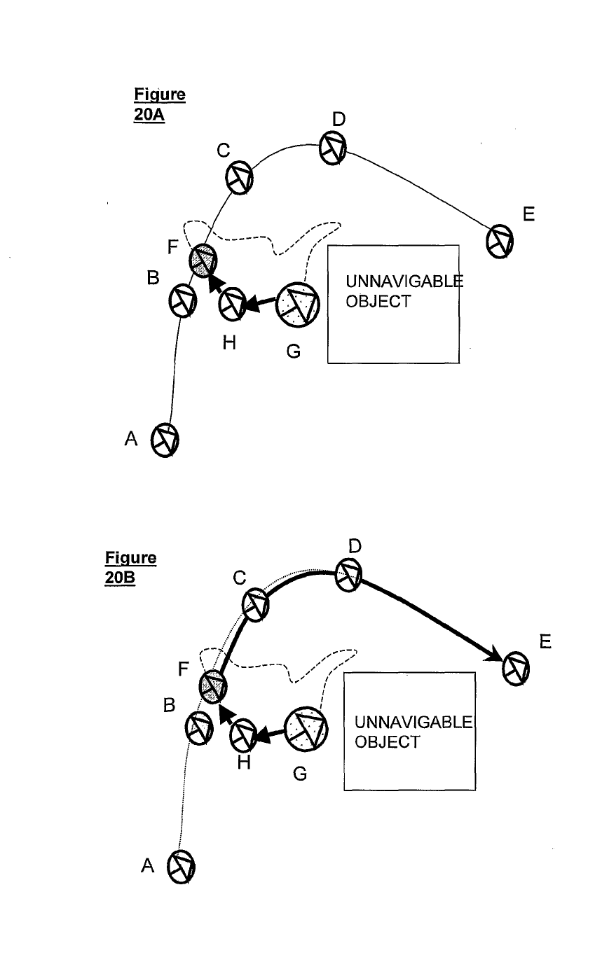

FIG. 20A shows an implementation of step 90 in FIG. 15. In FIG. 20A, a path has been determined back to the exit node F (via navigational node H for example). The exit node F then becomes the point of re-entry to the original guided path and all previous nodes lying along the original guided path are discarded (these comprise nodes A and B in FIG. 20B).

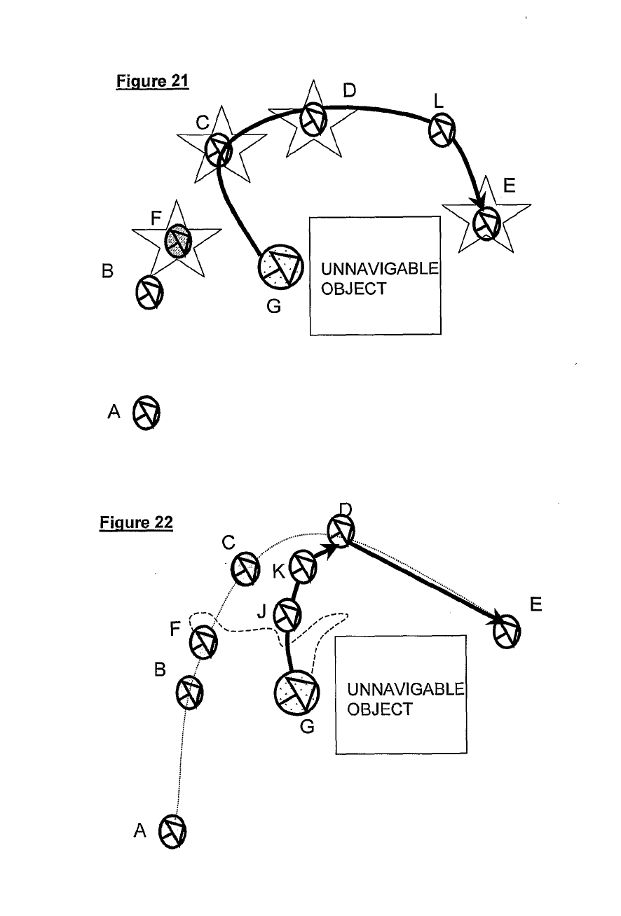

FIG. 21 shows an implementation of step 92 in FIG. 16. In the embodiment shown in FIG. 21, nodes C, D, and E, and F have had their interest_component increased to a higher value. When the pathfinding process is performed to determine a new path from start node G to destination node E, the increased interest_component of these nodes results in the new path generated passing through the nodes C and D as well as navigational node L to the destination node E.

FIG. 22 shows an implementation of step 92 shown in FIG. 17. In FIG. 22, a new path is plotted from new start node G to destination E. This takes in navigational nodes J and K, and then navigational node D. As navigational node D is associated with the original guided path from A to E, at navigational node D the new path resumes the original guided path to E. This reduces the computational complexity associated with computing the new path.

Thus the invention reduces the computational complexity of generating a return path in a virtual environment (i.e., in any virtual representation of a world). The topology of the virtual environment depends on the mesh density and configuration of the nodes forming the virtual world. If a user were not able to insert a new node wherever they wished to return to the automated navigation mode, a virtual world would need to be created with a nodal mesh density sufficiently high to anticipate all of the points where a user may end up if they were to navigate manually. This would increase the computational burden when generating the path for automated navigation, as well as increasing the computational complexity of the virtual world itself.

The contents of the inventor's copending International patent application entitled “Path Finding System” which claims priority from United Kingdom Patent Applications Nos. GB 0407385.4, GB0407311.0, and GB040739.0.4 are incorporated herein by reference. Those skilled in the art will appreciate that the invention as described herein with reference to the above description and appendices may be implemented by many features providing an equivalent function to the features described. Those skilled in the art will also realize that the invention is not limited to the embodiments disclosed herein, but extends in particular to include embodiments where it is apparent that a feature described in one embodiment of the invention described herein can be incorporated or adapted for incorporation into another embodiment of the invention or replaced by any feature having an equivalent function, such that the scope of the invention is as defined by the appended claims.

1. A method of generating a new path to a destination node in a virtual environment comprising a plurality of nodes, the method comprising:
storing nodal information identifying one or more nodes associated with a previously created path to said destination node;
dynamically reconfiguring the topology of the virtual environment to define a start node for said new path; and
processing said stored nodal information to determine the new path to said destination by including at least one node of said previously created path.

2. A method as claimed in claim 1, wherein when said previous path is no longer actively navigated along, an exit point is determined for said previous path.

3. A method as claimed in claim 2, wherein said exit point comprises a node on said previous path.

4. A method as claimed in claim 2, wherein said virtual environment is dynamically changed to include an node on said previous path, if said exit point does not comprise a node on said previous path.

5. A method as claimed in claim 1, wherein in said step of processing, a return path to said previously created path which intersects said previously created path at the nearest node to said start node for said new path is determined, and said new path includes said return path.

6. A method as claimed in claim 5, wherein said nearest node is determined by processing in parallel return paths to all nodes on said previous path.

7. A method as claimed in claim 3, wherein said new path includes all subsequent nodes of said previous path between said exit point and said destination.

8. A method as claimed in claim 3, wherein in said step of processing, a return path to said previously created path which intersects said previously created path at the exit point is determined, and said new path includes said return path.

9. A method as claimed in claim 1, wherein in said step of processing said stored nodal information to determine the new path to said destination by including at least one node of said previously created path, said nodal information is processed to increase the interest component of the nodes of said previous path.

10. A method as claimed in claim 1, wherein the navigation mode employed to navigate along said previously generated path is the same as the navigation mode employed to navigate along said new path.

11. A method as claimed in claim 10, wherein a user is guided along said previous path in an automatic navigation mode, and wherein said user is able to switch to a manual navigation mode to create a manually navigated path to said start node of said new path, and wherein said user is guided along said new path to said destination in an automatic navigation mode.

12. A method as claimed in claim 11, wherein said participant is able to switch between automatic navigation modes and manual navigation modes of their own volition at any point in said virtual environment.

13. A method as claimed in claim 10, wherein, when said participant switches from said automatic navigation mode to said manual navigation mode, an exit node is created along said previously created path.

14. A method of generating a return path to a portion of a previously created path in a virtual environment, wherein a user is able to be automatically navigated along the previously created path from a start node to a destination node, the virtual environment supporting the ability of the user to switch at their own volition from an automatic navigation mode along said previously created path to a manual navigation mode generating a second path which deviates from said previously created path in said virtual environment, the method comprising:
storing information identifying said start node, destination node and any intermediate nodes of said previously created path in said virtual environment;
dynamically reconfiguring the topology of the virtual environment to define a second start node at the point where said second path terminates; and
processing said nodal stored information to determine a return path from said second start node which intersects said previously created path at a re-entry node.

15. A method as claimed in claim 14, wherein an exit node is defined at a point along said first path where said second path commences, and said step of storing information comprises storing information identifying said exit node, start node, destination node and any intermediate nodes of said first path in said virtual environment.

16. A method as claimed in claim 15, further comprising performing the step of validating said first path using said stored information, and if said first path is still valid, performing the step of:
processing said nodal stored information to determine a return path from said second start node which intersects said first path at a re-entry node.

17. A method as claimed in claim 14, further comprising automatically navigating the user along the return path and the continued portion of said first path to said destination.

18. A method as claimed in claim 14, wherein in said step of processing said stored information, a parallel node search is performed from said second start node for all saved nodes of said first path to determine a return path from said second start node to a saved node of said first path.

19. A method as claimed in claim 14, wherein the closest saved node of the first path is determined as said re-entry node.

20. A method as claimed in claim 16, wherein the exit node of the first path is determined as said re-entry node.

21. A method as claimed in claim 1, wherein said user is a participant in said virtual environment.

22. A system arranged to support the generation of a new path to a destination node in a virtual environment comprising a plurality of nodes, the system comprising:
means to store nodal information identifying one or more nodes associated with a previously created path to said destination node;
means to dynamically reconfigure the topology of the virtual environment to define a start node for said new path; and
processing means to process said stored nodal information to determine the new path to said destination by including at least one node of said previously created path.

23. A system arranged to support the generation of a return path to a portion of a previously created path in a virtual environment, wherein a user is able to be automatically navigated along the previously created path from a start node to a destination node, the virtual environment supporting the ability of the user to switch at their own volition from an automatic navigation mode along said previously created path to a manual navigation mode generating a second path which deviates from said previously created path in said virtual environment, the system comprising:
means to store information identifying said start node, destination node and any intermediate nodes of said previously created path in said virtual environment; means to dynamically reconfigure the topology of the virtual environment to define a second start node at the point where said second path terminates; and
processing means to process said nodal stored information to determine a new path including return path from said second start node which intersects said previously created path at a re-entry node.

24. A system as claimed in claim 22, wherein the system further comprises means to enable a user to be automatically navigated along said previously created path.

25. A system as claimed in claim 24, wherein the system further comprises means to enable a user to switch from an automatic navigation model along said previously created path to a manually navigation mode and back to an automatic navigation along said new path.

26. A user interface for a computer system as claimed in claim 25, wherein the user interface is arranged to enable a user to switch from an automatic navigation model along said previously created path to a manually navigation mode and back to an automatic navigation along said new path.

27. A computer program comprising instructions for causing one or more processors to perform the method according to claim 1 when the instructions are executed by the processor or processors.

28. A computer data signal embodied in a carrier wave and representing instructions for causing one or more processors to perform the method according to claim 1 when the instructions are executed by the processor or processors.

29. A storage medium carrying computer readable code representing instructions for causing one or more processors to operate as the system according to claim 22 when the instructions are executed by the processor or processors.

30. A computer program comprising instructions for causing one or more processors to operate as the system according to claim 22 when the instructions are executed by the processor or processors.

31. A computer data signal embodied in a carrier wave and representing instructions for causing one or more processors to operate as the system according to claim 22 when the instructions are executed by the processor or processors.

32. A storage medium carrying computer readable code representing instructions for causing one or more processors to perform the method according to claim 1 when the instructions are executed by the processor or processors.
